(19) United States
(12) Patent Application Publication
(10) Pub. No.: US 2025/0073540 A1
(43) Pub. Date: Mar. 6, 2025

(54) BALL FOR RACKET SPORTS

(71) Applicant: Arlene Silva, Montpelier, VT (US)

(72) Inventor: Arlene Silva, Montpelier, VT (US)

(21) Appl. No.: 18/820,380

(22) Filed: Aug. 30, 2024

Related U.S. Application Data
(60) Provisional application No. 63/580,085, filed on Sep. 1, 2023.

(51) Int. Cl. A63B 37/00; A63B 102/08; C08L 101/12; G01N 21/95

(52) U.S. Cl. CPC A63B 37/0098; C08L 101/12; G01N 21/951; A63B 2102/08; A63B 2209/00

(57) ABSTRACT

A ball is configured for use in racket and paddle sport games. These configurations include a material composition that is sensitive to mechanical force. This composition may change colors in response to a crack or other defect in the surface of the ball. In one implementation, the ball may have a thin, peripheral wall that encloses a hollow interior. This ball may find use in pickleball and, thus, meets the requirements and parameters for use in the sport.

### CROSS-REFERENCE TO RELATED APPLICATIONS

This application claims the benefit of U.S. Ser. No. 63/580,085, filed on Sep. 1, 2023, and entitled “BALL FOR RACKET SPORTS.” The content of this application is incorporated by reference herein in its entirety.

### BACKGROUND

Racket and paddle sports are popular activities among individuals of different ages. Pickleball is a type of “paddle” game that continues to increase in popularity. In this game, participants use paddles to hit a hollow, perforated ball over a net. This ball is typically made of plastic. However, while useful for the game, use of this material makes the ball particularly susceptible to damage (like cracks) from (repeated) impact with the player's paddle or the court surface.

Any damage to the ball may adversely affect its performance for use in the game. As a result, participants often inspect the ball in between points, which can lead to delays or unnecessarily lengthen game play. But even a thorough inspection may fail to identify small or undiscernible cracks in the ball that will inevitably cause abnormal bounces or other unfair circumstances that can affect the outcome of the game.

### SUMMARY

The subject matter of this disclosure relates to improvements to a ball to better identify defects. Of particular interest are embodiments with a crack detection mechanism to help participants visualize cracks. The embodiments may comprise materials that change properties, for example, change in color in response to mechanical defects.

### DRAWINGS

Reference is now made briefly to the accompanying drawings, in which:

FIG. 1 depicts an elevation view of an exemplary embodiment of a ball; and

FIG. 2 depicts an elevation view of the ball of FIG. 1.

These drawings and any description herein represent examples that may disclose or explain the invention. The examples include the best mode and enable any person skilled in the art to practice the invention, including making and using any devices or systems and performing any incorporated methods. The drawings are not to scale unless the discussion indicates otherwise. Elements in the examples may appear in one or more of the several views or in combinations of the several views. The drawings may use like reference characters to designate identical or corresponding elements. Methods are exemplary only and may be modified by, for example, reordering, adding, removing, and/or altering individual steps or stages. The specification may identify such stages, as well as any parts, components, elements, or functions, in the singular with the word “a” or “an;” however, this should not exclude plural of any such designation, unless the specification explicitly recites or explains such exclusion. Likewise, any references to “one embodiment” or “one implementation” does not exclude the existence of additional embodiments or implementations that also incorporate the recited features.

### DESCRIPTION

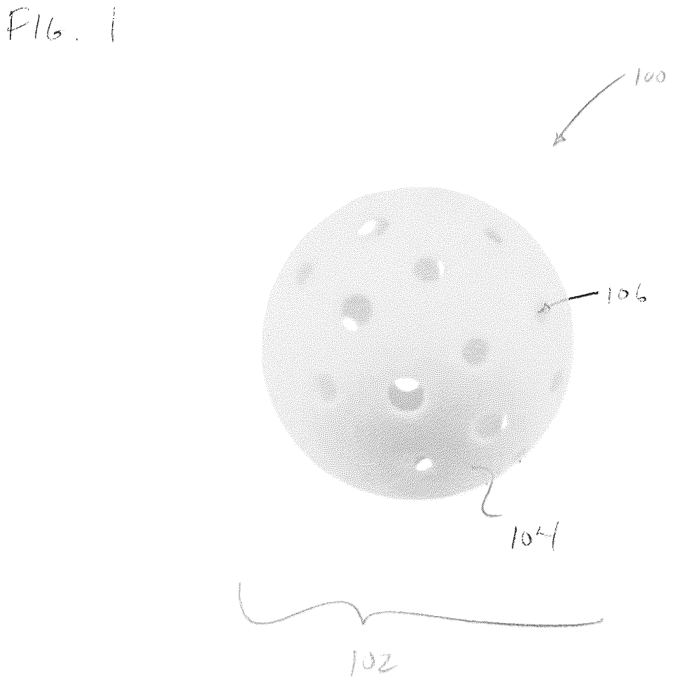

FIG. 1 depicts an elevation view of an example of a ball 100 that may be configured for use in various sports. These configurations may include racket sports, like pickleball, in which participants use rackets or paddles to strike the ball 100 over a net. As shown, this example has a body 102, typically having a spherical shape. The body 102 may have a thin wall 104 that forms a shell or an outer casing that encloses a hollow interior. Openings 106 may populate or perforate this shell.

The body 102 may be configured for the ball 100 to meet specifications for each individual sport. These configurations may conform to certain parameters or requirements, many of which are set out by game associations or standard-setting organizations. USA pickleball is an example of one of these organizations that promulgates standards or parameters for pickleballs, including parameters defined in its Equipment Standards Manual. These parameters may identify values for size, weight, dimensions, appearance, and the like. In one implementation, the body 102 meets requirements for indoor or outdoor pickleball. For example, the body 102 may form a hollow sphere that is round, preferably having a diameter of between 2.85 inches and 3.0 inches, within a tolerance or “out of round variance” that does not exceed 0.02 inches. This hollow sphere may have a weight of between 0.75 and 0.95 ounces. Its hardness may be between of between 35 and 55 (on the Durometer D scale) when measured at “ambient conditions,” including a temperature of 70° F.±5° F. The hollow sphere may also bounce at least 30 inches (and preferably between 30 and 34 inches) when dropped from about 78 inches above a pickleball court surface or onto a granite surface plate that is a minimum of 12 inches by 12 inches by 4 inches when measured at the ambient conditions. The hollow sphere may also yield an average compression test result of less than 43 lbf. The openings 106 may penetrate through the thin wall 104, for example, in an array of between 26 and 40 round or circular holes that are evenly or equally spaced apart from one another.

Materials for the body 102 may facilitate manufacture of the ball 100 to meet these parameters. These materials may comprise polymers, like plastics or thermoplastics (e.g., polypropylene), as well as resins or like organic compounds; however, this disclosure also contemplates use of other synthetic or non-synthetic materials. Exemplary materials include low-density polyethylene, high-density polyethylene, PET, or PVC. Use of certain materials may prevail to facilitate or comport with manufacture techniques, like molding, blow molding, injection molding, and the like. Additive manufacturing is another technique that may find use to manufacture the ball 100 in whole or in part.

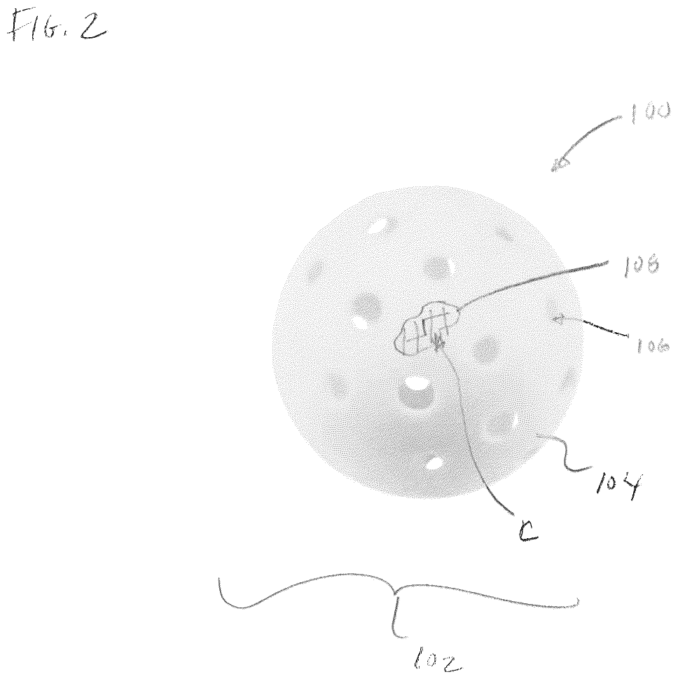

FIG. 2 shows an elevation view of an example of the ball 100. This example includes a crack detection area 108 that forms in response to an anomaly in the body 102. This anomaly may correspond with a crack C; however, this disclosure considers that the anomaly might comprise any split, perforation, avulsion, dent, puncture, or other defect in the body 102. These defects may significantly affect performance of the ball 100 in game play. In one implementation, the crack detection area 108 may have an appearance that is different from parts of the thin wall 104 that are adjacent to the anomaly. This appearance may alert the end user to the defect in the ball 100, which typically has a color that is uniform throughout at least its outer surface, but also possibly found homogenously through all or part of the thin wall 104. For example, the crack C itself or the area in proximity to the crack C (or the anomaly in general) may turn or appear in different color(s), shade(s), intensity(ies), or pigment(s) than the color of the ball 100. During game play, this feature may reduce time to inspect the ball 100 in between points, as well as to prevent the ball 100 to enter back into game play with a game-altering defect.

The crack detection area 108 may be configured to react to external stimuli. These configurations may include materials (or compounds or compositions) with properties that change or alter in response to a mechanical force, including stress, strain, pressure, shock, impact, or load. This “crack detection mechanism” may include mechanochromic polymers or like compositions, including those that change their absorption color in response to mechanical action or that change their emission or reflection color in response to mechanical action. Other materials may exhibit piezochromism, which causes the material to change color in response to changes in pressure (e.g., on a surface).

Manufacture of the ball 100 may incorporate these materials into the body 102. This feature may provide a composition that comprises the crack detection mechanism throughout the thin wall 104. The composition may be homogeneous, for example, the mechanochromic polymer is found throughout the thin wall 104. In one implementation, materials may form a matrix or mixture that includes materials with mechanochromic or piezochromic properties in composition with thermoplastic or plastic polymers to form the thin wall 104.

The examples below include certain elements or clauses one or more of which may be combined with other elements and clauses to describe embodiments contemplated within the scope and spirit of this disclosure. The scope may include and contemplate other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A pickleball, comprising:
a spherical, hollow body comprising a peripheral wall with perforations disposed therein, the peripheral wall having a composition that changes color in response to mechanical force.

2. The pickleball of claim 1, wherein the composition comprises mechanochromic polymers.

3. The pickleball of claim 1, wherein the composition is piezochromic.

4. The pickleball of claim 1, wherein the composition comprises thermoplastic polymers in combination with mechanochromic polymers.

5. The pickleball of claim 1, wherein the composition reacts to crack formation in the peripheral wall.

6. The pickleball of claim 1, wherein the composition reacts to changes in stress in the peripheral wall.

7. The pickleball of claim 1, wherein the composition reacts to changes in strain in the peripheral wall.

8. A pickleball, comprising:
a spherical hollow body comprising a perforated wall, the perforated wall having a composition that changes color in response to a defect formed therein.

9. The pickleball of claim 8, wherein the defect is a crack in the perforated wall.

10. The pickleball of claim 9, wherein the spherical hollow body meets specifications for USA pickleball.

11. The pickleball of claim 9, wherein the spherical hollow body bounces at least 30 inches, measured to the top of the spherical hollow body, when dropped from a height of 78 inches onto a granite surface plate that is a minimum of 12 inches by 12 inches by 4 inches at an ambient temperature of 70° F.±5° F.

12. The pickleball of claim 9, wherein the spherical hollow body bounces between 30 inches and 34 inches, measured to the top of the spherical hollow body, when dropped from a height of 78 inches onto a granite surface plate that is a minimum of 12 inches by 12 inches by 4 inches at an ambient temperature of 70° F.±5° F.

13. The pickleball of claim 9, wherein the spherical hollow body has a hardness of at least 40 on a durometer D scale at an ambient temperature of 70° F.±5° F.

14. The pickleball of claim 9, wherein the spherical hollow body has a hardness of between 40 and 50 on a durometer D scale at an ambient temperature of 70° F.±5° F.

15. The pickleball of claim 9, wherein the spherical hollow body yields an average compression test result of less than 43 lbf.

16. The pickleball of claim 9, wherein the perforated body comprises holes that are equally spaced from another.

17. The pickleball of claim 9, wherein the perforated wall has at least 26 circular holes.

18. The pickleball of claim 9, wherein the perforated wall has at most 40 circular holes.

19. The pickleball of claim 9, wherein the spherical hollow body weighs at least 0.78 ounces.

20. The pickleball of claim 9, wherein the spherical hollow body weighs between 0.78 ounces and 0.935 ounces.
